(19) United States
(12) Patent Application Publication
(10) Pub. No.: US 2017/0168542 A1
(43) Pub. Date: Jun. 15, 2017

(54) METHOD FOR PLAYING VIDEO AND ELECTRONIC DEVICE

(71) Applicants: LE HOLDINGS (BEIJING) CO., LTD., Beijing (CN); LE SHI INTERNET INFORMATION & TECHNOLOGY CORP., BEIJING, Beijing (CN)

(72) Inventor: Yuanhang REN, Beijing (CN)

(21) Appl. No.: 15/248,613

(22) Filed: Aug. 26, 2016

Related U.S. Application Data
(63) Continuation of application No. PCT/CN2016/089351, filed on Jul. 8, 2016.

(30) Foreign Application Priority Data
Dec. 10, 2015 (CN) 201510918384.X

(51) Int. Cl. G06F 1/32; H04N 5/04; H04N 5/46; H04N 19/42

(52) U.S. Cl. CPC G06F 1/325; H04N 19/42; G06F 1/3203; H04N 5/04; H04N 5/46

(57) ABSTRACT

The present disclosure discloses a method and a device for playing a video, wherein the method specifically comprises detecting a display status of a screen in a process of playing a video file, and stopping decoding and playing video data in the video file and continuing to decode and play audio data in the video file upon detecting a change of the display status of the screen from on to off.

### CROSS-REFERENCE TO RELATED APPLICATIONS

The present disclosure is a continuation of International Application No. PCT/CN2016/089351 filed on Jul. 8, 2016, which is based upon and claims priority to Chinese Patent Application No. 201510918384.X, filed on Dec. 10, 2015, and the entire contents of which are incorporated herein by reference.

### FIELD OF TECHNOLOGY

Embodiments of the present disclosure generally relate to the technical field of multimedia, and in particular, to a method for playing a video and an electronic device.

### BACKGROUND

With the rapid development of electronic technology, functions of terminal devices become stronger and stronger. For example, the terminal devices may have a photographing function, a hand-writing function, a music playing function, a video telephone function, a video playing function, etc., which are greatly convenient for daily lives of users. Cellphones have already become a necessary part in daily lives of users.

However, the stronger the functions of the terminal devices are, the higher the power consumption is. Especially, when a mobile terminal, for example, a cellphone, is used to watch a video, the power consumed is at least 4 times that of other applications. Moreover, the battery power of the mobile terminal is usually limited. For this reason, high power consumption during video playing becomes a big obstacle to the battery life of the mobile terminal, and also leads to waste of electric energy.

### SUMMARY

Embodiments of the present disclosure disclose a method and a device for playing a video, which are intended to overcome the detect of high power consumption of a terminal device when playing a video in the prior art, and to reduce the power consumption of a screen of the terminal device and prolong the battery life of the terminal device.

An embodiment of the present disclosure discloses a method for playing a video, including:
detecting a display status of a screen in a process of playing a video file;
stopping decoding and playing video data in the video file and continuing to decode and play audio data in the video file upon detecting a change of the display status of the screen from on to off.

Another aspect of the present disclosure discloses an electronic device for playing a video, including: at least one processor; and a memory communicably connected with the at least one processor for storing instructions executable by the at least one processor, wherein execution of the instructions by the at least one processor causes the at least one processor to:
detect a display status of a screen in a process of playing a video file; and
stop decoding and playing video data in the video file and continuously decode and play audio data in the video file upon detecting a change of the display status of the screen from on to off.

An embodiment of the present disclosure discloses a computer program, including computer-readable codes, wherein when the computer-readable codes are run on an electronic device, the electronic device is led to execute the method for playing the video above.

An embodiment of the present disclosure discloses a non-transitory computer-readable storage medium storing executable instructions that, when executed by an electronic device, cause the electronic device to: detect a display status of a screen in a process of playing a video file; and stop decoding and playing video data in the video file and continuously decode and play audio data in the video file upon detecting a change of the display status of the screen from on to off.

### BRIEF DESCRIPTION OF THE DRAWINGS

One or more embodiments are illustrated by way of example, and not by limitation, in the figures of the accompanying drawings, wherein elements having the same reference numeral designations represent like elements throughout. The drawings are not to scale, unless otherwise disclosed.

FIG. 1 shows a step flow diagram of some embodiments of a method for playing a video of the present disclosure.

FIG. 2 shows a step flow diagram of some embodiments of a method for playing a video of the present disclosure.

FIG. 3 shows a step flow diagram of some embodiments of a method for playing a video of the present disclosure.

FIG. 4 shows a structure block diagram of some embodiments of a device for playing a video of the present disclosure.

FIG. 5 shows a structure block diagram of some embodiment of a device for playing a video of the present disclosure.

FIG. 6 exemplarily shows a block diagram of an electronic device for executing methods according to some embodiments of the present disclosure.

FIG. 7 exemplarily shows a storage unit for holding or carrying program codes for executing methods according to some embodiments of the present disclosure.

### DESCRIPTION OF THE EMBODIMENTS

In order to make the objectives, technical solutions and advantages of the embodiments of the present disclosure more clear, the technical solutions in the embodiments of the present disclosure will be described below clearly and completely in conjunction with the accompanying drawings in the embodiments of the present disclosure. Apparently, the described embodiments are part of embodiments of the present disclosure, but not all embodiments. On the basis of the embodiments in the present disclosure, all the other embodiments obtained by a person skilled in the art without creative work should fall into the scope of protection of the present disclosure.

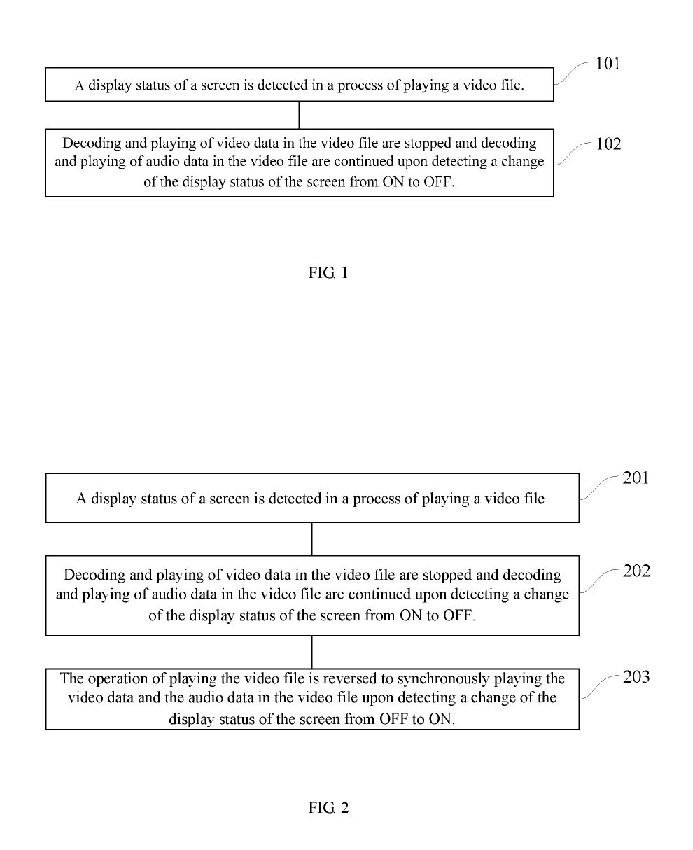

By referring to FIG. 1, which shows the step flow diagram of some embodiments of the method for playing a video of the present disclosure, the method may specifically include the steps as follows.

In Step 101, a display status of a screen is detected in a process of playing a video file.

This embodiment of the present disclosure is applicable to any terminal device capable of playing videos. The terminal device can be a cellphone, a smart phone, a laptop computer, a PC (personal computer), an e-book terminal, a digital broadcasting terminal, a PDA (Personal Digital Assistant), a portable multimedia player, a navigation system, or the like. It can be appreciated that the specific terminal device is not limited in the embodiment of the present disclosure. For the sake of convenient illustration, the cellphone is taken as an example for descriptions in the embodiment of the present disclosure; other terminal devices may refer to each other.

In this embodiment of the present disclosure, the video file may be one of video files of various common formats, such as AVI (Audio Video Interleaved) (with the extension of *.avi), MPEG (Moving Picture Experts Group) (with the extension of *.mpg), MPEG-4 (with the extension of *.mp4), WMV (Windows Media Video) (with the extension of *.wmv), MKV (Multimedia Container) (with the extension of *.mkv), and the like. The specific format of the video file played is not limited in the embodiment of the present disclosure.

In an alternative embodiment of the present disclosure, the step of playing the video file may specifically include the substeps as follows.

In Substep S11, separation processing is performed on the video file to obtain video data and audio data separately.

In Substep S12, the video data and the audio data are decoded and synchronously played.

In specific application, a video file typically includes video data and audio data. In this embodiment of the present disclosure, separation processing is performed on the video file to obtain the video data and the audio data. When the video file is played by a terminal device, the video data and the audio data are decoded separately, and then played synchronously according to a timestamp. The above playing mode is referred to as a video playing mode in the embodiment of the present disclosure, i.e., a video-audio combined playing mode.

However, in practical application, when a user watches a video on a terminal device (e.g., a cellphone), usually, it is likely that the user just wants to listen to the voice of the video rather than watching the images of the video. For example, for comic dialogue and lecture type video, a user may prefer to listen to these video programs by means of an earphone in a screen-locked state on occasions, e.g., on a bus, where a cellphone is inconvenient to hold. In this way, the demand of the user listening to video programs can be satisfied, and the power consumption of the screen of the cellphone may also be decreased.

In order to solve the above problem, the display status of the screen is detected in the process of playing video file in this embodiment of the present disclosure.

In Step 102, decoding and playing of video data in the video file are stopped and decoding and playing of audio data in the video file are continued upon detecting a change of the display status of the screen from on to off.

In an alternative embodiment of the present disclosure, the change of the display status of the screen from on to off may be triggered in any way as follows:
a screen turn-off command from a hardware button is received, thereby triggering the change of the display status of the screen from on to off;
the change of the display status of the screen from on to off is automatically triggered when no operation behavior to a terminal is detected within preset time.

In this embodiment of the present disclosure, if a user only wants to listen to a video program, the user can press down a hardware button of turning off the screen, e.g., a power button. That is, the user sends an audio switching request by pressing down the hardware button of turning off the screen; the audio switching request is meant to switch a video playing mode to an audio playing mode. In addition, the above switching request may also be automatically triggered by hardware. For example, the screen of the cellphone may be turned off automatically if no operation is performed within certain time, and then a video played currently may be switched to the audio playing mode.

When the audio switching request is received from the user, i.e., when the change of the display status of the screen from on to off is detected, decoding and playing of the video data in the video file may be stopped, while decoding and playing of the audio data in the video file are continued. In this case, it is realized that the video playing mode is switched to the audio playing mode. In this embodiment of the present disclosure, the video playing mode may be switched to the audio playing mode just by clicking the power button. The operation is simple and convenient, and the experience of the user can be enhanced.

The above operation of stopping decoding and playing the video data specifically refers to stopping such operations as decoding and rendering to the video data and not displaying the video data; system resources occupied by video decoding thus can be released, and then saved. In addition, as the status of the screen is off, the power can be saved. In particular for a battery-powered terminal device, an excellent energy-saving effect can be achieved.

When a terminal device (e.g., a cellphone) is used to play a video file, great power may be consumed. According to this embodiment of the present disclosure, the operation of stopping playing is performed on the video data in the video file played currently, and only the audio data is played. In this way, a program playing demand that only voice is required regardless of video images can be satisfied, and unnecessary power consumption can be reduced to prolong the battery life of the terminal device.

In another alternative embodiment of the present disclosure, the method may also include:
when detecting a rotation of the screen from up to down in the process of playing the video file, stopping decoding and playing the video data in the video file, and continuing to decode and play the audio data in the video file.

In yet another alternative embodiment of the present disclosure, the method may also include:
when detecting a rotation of the screen from down to up in the process of playing the video file, reversing the operation of playing the video file to synchronously playing the video data and the audio data in the video file.

In practical application, in the video playing process, when detecting that the screen of the cellphone rotates down by means of gravity sensing, it can also be sure that the user does not want to watch the video content, and then the playing mode is switched to the audio playing mode. Compared with simultaneously playing the video data and the audio data, the burden of the CPU of the cellphone can be reduced. When detecting that the screen rotates up from down, the playing mode is switched to the video playing mode, i.e., synchronously playing the audio data and the audio data in the video file.

In conclusion, according to this embodiment of the present disclosure, in the process of playing the video file, when the change of the display status of the screen from on to off is detected, decoding and playing of the video data in the video file are stopped, while decoding and playing of the audio data in the video file are continued. In practical application, since some video programs have low requirements on images and the demand of a user can be satisfied as long as there is voice, for example, comic dialogue, news, and music MV, playing of a video part in a video file can be stopped, and only an audio part in the video file is played while a screen is turned off Therefore, the power consumption of the screen can be reduced, and the battery life of a terminal device can be prolonged.

This embodiment based on the above first embodiment may also include the following optional technical solutions. In this embodiment, after the video playing mode is switched to the audio playing mode, the audio playing mode may also be switched back to the video playing mode according to the requirement of a user.

By referring to FIG. 2, which shows the step flow diagram of some embodiments of the method for playing a video of the present disclosure, the method may specifically include the following steps:

In Step 201, a display status of a screen is detected in a process of playing a video file.

In Step 202, decoding and playing of video data in the video file are stopped and decoding and playing of audio data in the video file are continued upon detecting a change of the display status of the screen from on to off.

In Step 203, the operation of playing the video file is reversed to synchronously playing the video data and the audio data in the video file upon detecting a change of the display status of the screen from off to on.

In this embodiment of the present disclosure, if a user wants to continue to watch a video program, the user can press down a hardware button of turning on the screen, e.g., a power button. That is, the user sends a video switching request by pressing down the hardware button of turning on the screen; the video switching request is meant to switch an audio playing mode to a video playing mode.

When the video switching request is received from the user, i.e., when the change of the display status of the screen from off to on is detected, the video data and the audio data in the video file can be played synchronously while the screen is unlocked. In this case, it is realized that the audio playing mode is switched to the video playing mode.

In an alternative embodiment of the present disclosure, the step of synchronously playing the video data and the audio data in the video file may specifically include the substeps as follows.

In Substep S21, a current playing time point of the audio data is obtained.

In Substep S22, the video data and the audio data are decoded and synchronously played from positions corresponding to the time point.

When the change of the display status of the screen from off to on is detected, before the audio playing mode is switched back to the video playing mode, the playing of the audio data can be suspended first, and the current playing time point T of the audio data is obtained. Second, a position of the video corresponding to the moment T is searched. Finally, the video data and the audio data are recoded separately and played synchronously from the audio position and the video position corresponding to the moment T.

In this embodiment of the present disclosure, in the process of playing the video file, when the change of the display status of the screen from on to off is detected, decoding and playing of the video data in the video file are stopped, while decoding and playing of the audio data in the video file are continued. A demand that a user only requires voice regardless of images can be satisfied. Only the audio part in the video file is played while the screen is turned off. Therefore, the power consumption of the screen can be reduced, and the battery life of a terminal device can be prolonged. When the change of the display status of the screen from off to on is detected, the video data and the audio data in the video file can be played synchronously again. According to the embodiment of the present disclosure, mutual switching of the video playing mode and the audio playing mode of the video file can be realized flexibly; therefore, different requirements of a user can be met.

In specific application, common files, such as AVI, MP4, MKV, WMV, and the like, actually are encapsulation standards. A complete video file is typically composed of two parts, namely audio and video. H264, Xvid, and so on are video coding formations, while MP3, AAC, and so on are audio coding formats. For example, an Xvid video coded file and an MP3 audio coded file are encapsulated according to the AVI encapsulation standard to obtain an AVI-suffixed video file, i.e., a commonly used AVI video file. The above first embodiment or second embodiment can be applied to the video files of the above types. When a video file is played, the video part and the audio part therein are coded separately and played synchronously. When the change of the display status of the screen from on to off is detected, decoding and playing of the video data in the video file are stopped, while decoding and playing of the audio data in the video file are continued. Therefore, it is realized that the video playing mode is switched to the audio playing mode, such that the power consumption of a terminal device is saved.

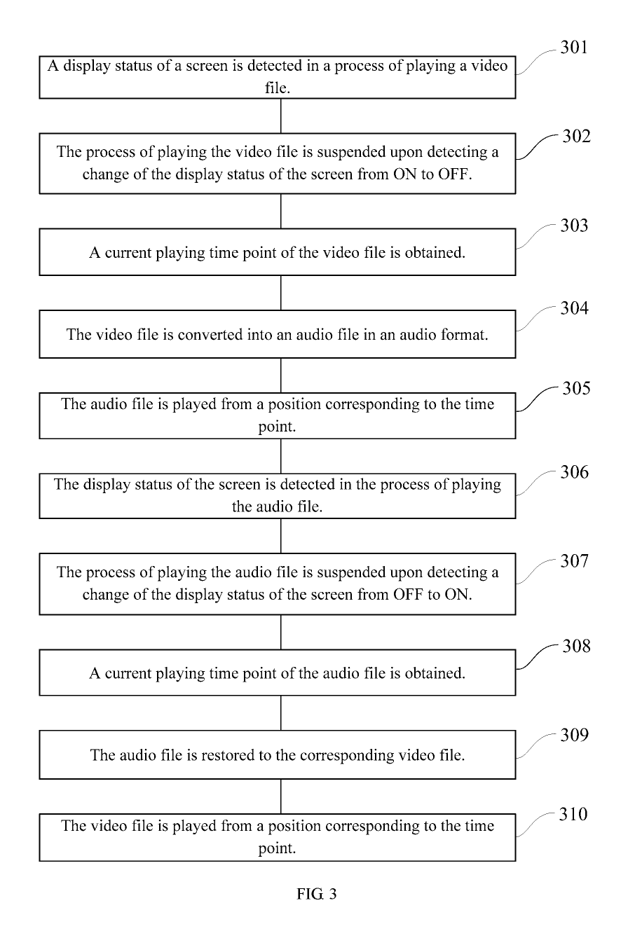

This application example is applied to a video file without an independent audio coded file. For example, a video filmed by using a cellphone is the video without the independent audio coded file. By referring to FIG. 3, which shows the step flow diagram of some embodiments of the method for playing a video of the present disclosure, the method may specifically include the steps as follows.

In Step 301, a display status of a screen is detected in a process of playing a video file.

In Step 302, the process of playing the video file is suspended upon detecting a change of the display status of the screen from on to off.

In Step 303, a current playing time point of the video file is obtained.

In Step 304, the video file is converted into an audio file in an audio-only format.

Specifically, the video file may be decoded to separate out video data and audio data, and then the audio data is coded into an audio file of a preset format. The format of the generated audio file may be one of such formats as mp3, m4a, ac3, aac, wma, way and flac. Further, parameters, such as an encapsulation format, a video frame rate, and the like, of the video file obtained by decoding may be buffered.

In this embodiment of the present disclosure, the video file and the converted audio file can be stored in a server or locally, and a mapping relation between the video file and the audio file is established, such that the corresponding video file or audio file can be directly found out from the server or locally according to the mapping relation; therefore, mutual switching of the video playing mode and the audio playing mode is facilitated.

In Step 305, the audio file is played from a position corresponding to the time point.

In an alternative embodiment of the present disclosure, the method may also include the steps as follows.

In Step 306, the display status of the screen is detected in the process of playing the audio file.

In Step 307, the process of playing the audio file is suspended upon detecting a change of the display status of the screen from off to on.

In Step 308, a current playing time point of the audio file is obtained.

In Step 309, the audio file is restored to the corresponding video file.

Specifically, the audio file can be restored to the video file according to the buffered parameters, such as the encapsulation format, the video frame rate, and the like, of the video file.

Optionally, the stored video file can be directly found out by means of the above established mapping relation between the video file and the audio file; the video file thus can be played starting from the corresponding time point.

In Step 310, the video file is played from a position corresponding to the time point.

It can be appreciated that in practical application, an appropriate converting method can be selected flexibly by a person skilled in the art to convert a video file into an audio file or converting an audio file into a video file. The specific converting method between a video file and an audio file is not limited in the present disclosure. For example, such tools as Format Factory, or a written converting program can be used for converting.

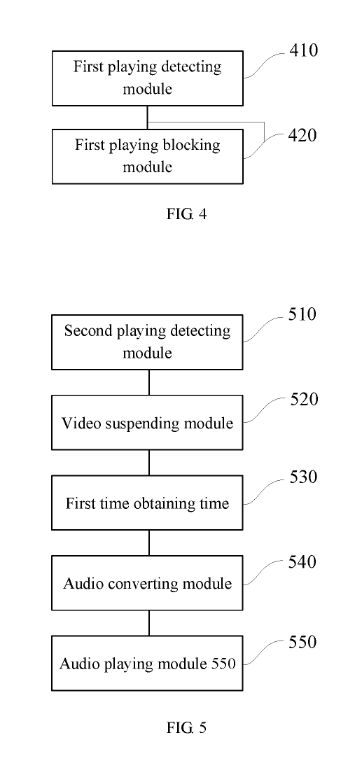

By referring to FIG. 4, which shows the structure block diagram of some embodiments of the device for playing a video of the present disclosure, the device may specifically include:
a first playing detecting module 410 configured to detect a display status of a screen in a process of playing a video file;
a first playing blocking module 420 configured to stop decoding and playing video data in the video file and continuously decode and play audio data in the video file upon detecting a change of the display status of the screen from on to off.

In an alternative embodiment of the present disclosure, the first playing detecting module 410 may specifically include:
a separating submodule configured to perform separation processing on the video file to obtain video data and audio data separately;
a playing submodule configured to decode and synchronously play the video data and the audio data.

In another alternative embodiment of the present disclosure, the device may also include:
a first playing reversing module configured to reverse the operation of playing the video file to synchronously playing the video data and the audio data in the video file upon detecting a change of the display status of the screen from off to on.

In yet another alternative embodiment of the present disclosure, the device may also include:
a time obtaining submodule configured to obtain a current playing time point of the audio data;
a synchronous playing submodule configured to decode and synchronously play the video data and the audio data from positions corresponding to the time point.

In still another alternative embodiment of the present disclosure, the device may also include:
a second playing blocking module configured to stop decoding and playing the video data in the video file and continuously decode and play the audio data in the video file upon detecting a rotation of the screen from up to down in the process of playing the video file.

In still another alternative embodiment of the present disclosure, the device may also include:
a second playing reversing module configured to reverse the operation of playing the video file to synchronously playing the video data and the audio data in the video file upon detecting a rotation of the screen from down to up in the process of playing the video file.

By referring to FIG. 5, which shows the structure block diagram of some embodiments of the device for playing a video of the present disclosure, the device may specifically include:
a second playing detecting module 510 configured to detect a display status of a screen in a process of playing a video file;
a video suspending module 520 configured to suspend the process of playing the video file upon detecting a change of the display status of the screen from on to off;
a first time obtaining time 530 configured to obtain a current playing time point of the video file;
an audio converting module 540 configured to convert the video file into an audio file in an audio-only format; and
an audio playing module 550 configured to play the audio file from a position corresponding to the time point.

In an alternative embodiment of the present disclosure, the device may also include:
a third playing detecting module configured to detect the display status of the screen in the process of playing the audio file;
an audio suspending module configured to suspend the process of playing the audio file upon detecting a change of the display status of the screen from off to on;
a second time obtaining module configured to obtain a current playing time point of the audio file;
a video converting module configured to restore the audio file to the corresponding video file;
a video playing module configured to play the video file from a position corresponding to the time point.

The device embodiments described above are merely exemplary, wherein the modules illustrated as separate components may be physically separated or not. Components displayed as modules may be physical modules or not, which can be located at the same place or distributed to a plurality of network modules. Part or all modules may be selected according to actual requirements to achieve the purposes of the solutions of the embodiments. A person skilled in the art can understand and implement the solutions without creative work.

According to the descriptions of the above embodiments, a person skilled in the art could clearly learn that the embodiments may be realized by means of software and a necessary general hardware platform, and of course, may also be realized by hardware. Based on such a understanding, the above technical solutions substantially or the part making contribution to the prior art may be embodied in the form of a software product, and the computer software product may be stored in a computer-readable storage medium, such as an ROM/RAM, a magnetic disk, an optical disk, or the like, which includes a plurality of commands for enabling computer equipment (which may be a personal computer, a server, network equipment, or the like) to execute each embodiment or methods mentioned in some parts of the embodiments.

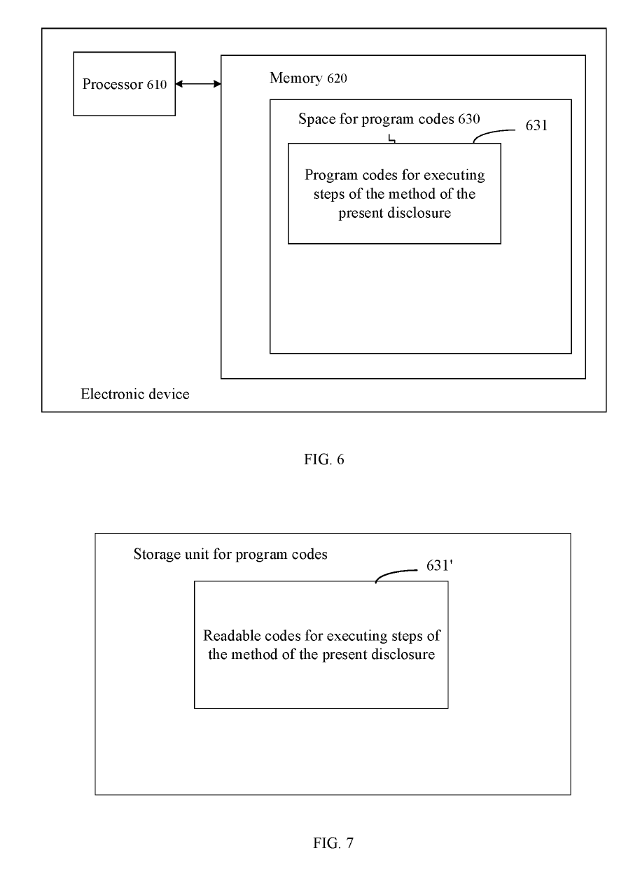

For example, FIG. 6 illustrates a block diagram of an electronic device for executing the method according the some embodiments of the disclosure. The electronic device may be a terminal above. Traditionally, the electronic device includes a processor 610 and a computer program product or a computer readable medium in form of a memory 620. The memory 620 could be electronic memories such as flash memory, EEPROM (Electrically Erasable Programmable Read - Only Memory), EPROM, hard disk or ROM. The memory 620 has a memory space 630 for executing program codes 631 of any steps in the above methods. For example, the memory space 630 for program codes may include respective program codes 631 for implementing the respective steps in the method as mentioned above. These program codes may be read from and/or be written into one or more computer program products. These computer program products include program code carriers such as hard disk, compact disk (CD), memory card or floppy disk. These computer program products are usually the portable or stable memory cells as shown in reference FIG. 7. The memory cells may be provided with memory sections, memory spaces, etc., similar to the memory 620 of the electronic device as shown in FIG. 6. The program codes may be compressed for example in an appropriate form. Usually, the memory cell includes computer readable codes 631′ which can be read for example by processors 610. When these codes are operated on the electronic, the server may execute respective steps in the method as described above.

Finally, it should be noted that the above embodiments are merely used for illustrating the technical solutions of the present disclosure, rather than limiting the present disclosure. Although the present disclosure is illustrated in detail with reference to the aforementioned embodiments, it should be understood by a person skilled in the art that modifications may still be made to the technical solutions described in the aforementioned embodiments, or equivalent alternatives may be applied to part of technical characteristics therein; and these modifications or alternatives do not cause the nature of the corresponding technical solutions to depart from the spirit and scope of the technical solutions of the embodiments of the present disclosure.

What is claimed:

1. A method for playing a video, comprising:
detecting a display status of a screen in a process of playing a video file;
stopping decoding and playing video data in the video file and continuing to decode and play audio data in the video file upon detecting a change of the display status of the screen from on to off.

2. The method according to claim 1, wherein the playing the video file comprises:
performing separation processing on the video file to obtain video data and audio data separately;
decoding and synchronously playing the video data and the audio data.

3. The method according to claim 1, further comprising:
reversing the operation of playing the video file to synchronously playing the video data and the audio data in the video file upon detecting a change of the display status of the screen from off to on.

4. The method according to claim 3, wherein the step of synchronously playing the video data and the audio data in the video file comprises:
obtaining a current playing time point of the audio data;
decoding and synchronously playing the video data and the audio data from positions corresponding to the time point.

5. The method according to claim 1, wherein the change of the display status of the screen from on to off is triggered in the following way:
receiving a screen turn-off command from a hardware button, thereby triggering the change of the display status of the screen from on to off; or
automatically triggering the change of the display status of the screen from on to off when no operation behavior to a terminal is detected within preset time.

6. The method according to claim 1, further comprising:
when detecting a rotation of the screen from up to down in the process of playing the video file, stopping decoding and playing the video data in the video file, and continuing to decode and play the audio data in the video file.

7. The method according to claim 6, further comprising:
when detecting a rotation of the screen from down to up in the process of playing the video file, reversing the operation of playing the video file to synchronously playing the video data and the audio data in the video file.

8. An electronic device, comprising:
at least one processor; and
a memory communicably connected with the at least one processor for storing instructions executable by the at least one processor, wherein execution of the instructions by the at least one processor causes the at least one processor to:
detect a display status of a screen in a process of playing a video file; and
stop decoding and playing video data in the video file and continuously decode and play audio data in the video file upon detecting a change of the display status of the screen from on to off.

9. The electronic device according to claim 8, wherein the step to detect a display status of a screen in a process of playing a video file comprises:
performing separation processing on the video file to obtain video data and audio data separately;
decoding and synchronously playing the video data and the audio data.

10. The electronic device according to claim 8, wherein execution of the instructions by the at least one processor further causes the at least one processor to:
reverse the operation of playing the video file to synchronously playing the video data and the audio data in the video file upon detecting a change of the display status of the screen from off to on.

11. The electronic device according to claim 10, wherein the step to reverse the operation of playing the video file to synchronously playing the video data and the audio data in the video file upon detecting a change of the display status of the screen from off to on comprises:
obtaining a current playing time point of the audio data;
decoding and synchronously playing the video data and the audio data from positions corresponding to the time point.

12. The electronic device according to claim 8, wherein execution of the instructions by the at least one first processor further causes the at least one first processor to:
stop decoding and playing the video data in the video file and continuously decode and play the audio data in the video file upon detecting a rotation of the screen from up to down in the process of playing the video file.

13. The electronic device according to claim 12, wherein execution of the instructions by the at least one first processor further causes the at least one first processor to:
reverse the operation of playing the video file to synchronously playing the video data and the audio data in the video file upon detecting a rotation of the screen from down to up in the process of playing the video file.

14. A non-transitory computer-readable storage medium storing executable instructions that, when executed by an electronic device, cause the electronic device to:
detect a display status of a screen in a process of playing a video file; and
stop decoding and playing video data in the video file and continuously decode and play audio data in the video file upon detecting a change of the display status of the screen from on to off.

15. The non-transitory computer-readable storage medium according to claim 14, wherein the step to play the video file comprises:
performing separation processing on the video file to obtain video data and audio data separately;
decoding and synchronously playing the video data and the audio data.

16. The non-transitory computer-readable storage medium according to claim 14, wherein the electronic device is further caused to:
reverse the operation of playing the video file to synchronously playing the video data and the audio data in the video file upon detecting a change of the display status of the screen from off to on.

17. The non-transitory computer-readable storage medium according to claim 16, wherein synchronously playing the video data and the audio data in the video file comprises:
obtaining a current playing time point of the audio data;
decoding and synchronously playing the video data and the audio data from positions corresponding to the time point.

18. The non-transitory computer-readable storage medium according to claim 14, wherein the change of the display status of the screen from on to off is triggered in the following way:
receiving a screen turn-off command from a hardware button, thereby triggering the change of the display status of the screen from on to off; or
automatically triggering the change of the display status of the screen from on to off when no operation behavior to a terminal is detected within preset time.

19. The non-transitory computer-readable storage medium according to claim 14, wherein the electronic device is further caused to:
stop decoding and playing the video data in the video file, and continue to decode and play the audio data in the video file when detecting a rotation of the screen from up to down in the process of playing the video file.

20. The non-transitory computer-readable storage medium according to claim 19, wherein the electronic device is further caused to:
reverse the operation of playing the video file to synchronously playing the video data and the audio data in the video file when detecting a rotation of the screen from down to up in the process of playing the video file.
